(19) United States
(12) Patent Application Publication
(10) Pub. No.: US 2025/0153489 A1
(43) Pub. Date: May 15, 2025

(54) SHEET STACKING APPARATUS AND IMAGE FORMING APPARATUS

(71) Applicant: CANON KABUSHIKI KAISHA, Tokyo (JP)

(72) Inventors: TOSHIYUKI ICHIKAWA, Ibaraki (JP); YUYA YOKOBORI, Chiba (JP); KAKERU TAKAHASHI, Tokyo (JP)

(21) Appl. No.: 18/938,556

(22) Filed: Nov. 6, 2024

(30) Foreign Application Priority Data
Nov. 10, 2023 (JP) 2023-192099

(51) Int. Cl. B41J 11/00; B41J 11/58; B41J 13/10

(52) U.S. Cl. CPC B41J 11/0015; B41J 11/58; B41J 13/103

(57) ABSTRACT

A sheet stacking apparatus including: a storage on which a sheet is placed; a sheet feeding portion configured to feed the sheet placed on the storage; an electrical component; a storage frame in which the storage and the electrical component are stored; a power supply portion provided outside the storage frame and configured to supply power to the electrical component; a cable configured to connect the electrical component and the power supply portion via an opening portion provided in the storage frame; and a seal member provided between the opening portion and the cable.

### BACKGROUND OF THE DISCLOSURE

### Field of the Disclosure

The present disclosure relates to a sheet stacking apparatus which stores sheets, conveys the stored sheets, and has a sealability, and to an image forming apparatus.

### Description of the Related Art

In the printing industry in recent years, there is a demand for an industrial ink jet printing machine which can realize high productivity and high-quality products. In the industrial ink jet printing machine, a print head prints on a sheet, but a print gap, which is a clearance between the print head and the sheet, greatly affects image quality. A state in which the print gap disappears due to sheet deformation is called a head touch. The head touch not only degrades the quality of the product but may also lead to breakage of the print head.

When the printing machine is installed in a high humidity environment, the before-printing sheets in the sheet stacking apparatus may absorb moisture in the high humidity environment, causing undulations in the sheet. The deformation of the sheet due to undulations leads to the reduction of the print gap. Therefore, even when the printing machine is installed in the high humidity environment, it is necessary to prevent the sheets in the sheet stacking apparatus from absorbing moisture in the high humidity environment. Japanese Patent Application Laid-Open No. H09-236953 discloses that a humidity adjusting device comprising a dehumidifying heater and a humidifier is provided in a cassette, in which sheets of transfer paper are stored, to adjust the humidity in the cassette and maintain the moisture content of the transfer paper within a predetermined range. Japanese Patent Application Laid-Open No. H09-132330 discloses that a magazine having a housing in which sheets are stored and a lid that can be opened and closed with respect to the housing has a moisture-proof structure at all abutment portions between the housing and the lid.

However, in the configuration of Japanese Patent Application Laid-Open No. H09-236953, the installation of the humidity adjusting device increases the size of the apparatus. In the configuration of Japanese Patent Application Laid-Open No. H09-132330, for example, in order to arrange a load component such as an air loosening fan in the magazine, it is necessary to pass an electrical cable from the inside of the magazine to the outside. If an opening portion is provided in the magazine in order to pass the cable, the moisture resistance of the inside of the magazine cannot be maintained.

### SUMMARY OF THE DISCLOSURE

According to an aspect of the present disclosure, a sheet stacking apparatus includes: a storage on which a sheet is placed; a sheet feeding portion configured to feed the sheet placed on the storage; an electrical component; a storage frame in which the storage and the electrical component are stored; a power supply portion provided outside the storage frame and configured to supply power to the electrical component; a cable configured to connect the electrical component and the power supply portion via an opening portion provided in the storage frame; and a seal member provided between the opening portion and the cable.

Further features of the present disclosure will become apparent from the following description of exemplary embodiments with reference to the attached drawings.

### BRIEF DESCRIPTION OF THE DRAWINGS

FIG. 1 is a cross-sectional view of an ink jet recording apparatus.

FIG. 2 is a perspective view of a feeding module in a state in which a storage is pulled out.

FIG. 3 is a perspective view of the storage.

FIG. 4 is a perspective view of a sealed frame and the storage.

FIG. 5 is a cross-sectional view of the sealed frame and the storage taken along line V-V in FIG. 4.

FIG. 6 is an enlarged cross-sectional view of a portion enclosed by a dot and dash line rectangle VI in FIG. 5.

FIG. 7 is a perspective view of the sealed frame as seen from a back side.

FIG. 8 is a perspective view of a sealing cover attached to a back side plate.

FIG. 9A is a schematic view of a cross section of a cable.

FIG. 9B is a schematic view of a cross section of an opening portion.

FIG. 9C is a schematic view of a cross section of a seal member.

FIG. 10A and FIG. 10B are cross-sectional views of a two-part seal member taken along line X-X of FIG. 8.

### DESCRIPTION OF THE EMBODIMENTS

Hereinafter, the present disclosure will be described using the embodiments. It should be noted that the scope of the present disclosure is not limited to the embodiments described below, and it should not be construed that all the configurations described in the embodiments are the essential structural features of the present disclosure.

### Ink Jet Recording Apparatus

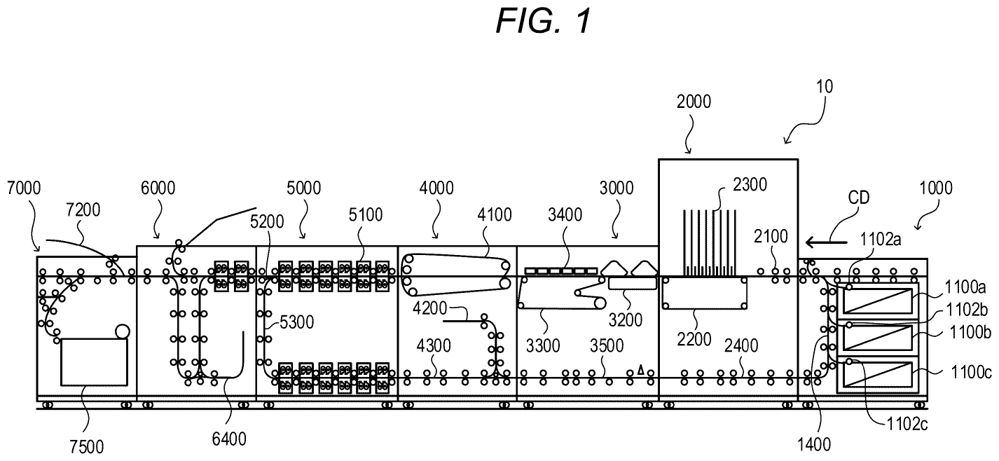

Hereinafter, an ink jet recording apparatus 10 will be described as an example of an image forming apparatus according to the embodiment with reference to the accompanying drawings. However, the image forming apparatus is not limited to the ink jet recording apparatus 10, and may be, for example, an electrophotographic image forming apparatus configured to form a toner image on a sheet. FIG. 1 is a cross-sectional view of the ink jet recording apparatus 10. The ink jet recording apparatus 10 is of a sheet-fed type and forms an ink image (image) on a sheet using two liquids comprising a reaction liquid and an ink. The ink jet recording apparatus 10 includes a feeding module (sheet stacking apparatus) 1000, a print module 2000, a drying module 3000, a fixing module 4000, a cooling module 5000, a reversing module 6000, and a discharge stacking module 7000. A cut sheet (hereinafter referred to as a sheet) fed from the feeding module 1000 is conveyed along a conveyance path, processed in each module, and discharged to the discharge stacking module 7000.

### Feeding Module

The feeding module 1000 includes three storages 1100a, 1100b, and 1100c, which respectively store a plurality of sheets. The storages 1100a, 1100b, and 1100c are configured to be able to be pulled out to the front side of the feeding module 1000. The sheets stored in the storages 1100a, 1100b, and 1100c are conveyed one by one to the print module 2000 in a conveyance direction CD by feeding portions 1102a, 1102b, and 1102c as conveyance units including separation belts and conveyance rollers. The number of the storages 1100a, 1100b, and 1100c is not limited to 3, but may be 1, 2, or 4 or more.

### Print Module

The print module 2000 includes a before-image-formation registration correction portion 2100, a print belt unit 2200, and a recording portion (image forming portion) 2300. The sheet conveyed from the feeding module 1000 is conveyed to the print belt unit 2200 after the inclination and position of the sheet are corrected by the before-image-formation registration correction portion 2100. The recording portion 2300 is arranged opposite to the print belt unit 2200 across the conveyance path. The recording portion 2300 is an image forming portion that forms an ink image by performing a recording process (printing) on the sheet, which is being conveyed, by a recording head from above. The sheet is sucked and conveyed by the print belt unit 2200 to ensure a clearance (print gap) between the sheet and the recording head.

A plurality of recording heads provided in the recording portion 2300 are arranged along the conveyance direction CD. In the embodiment, the recording portion 2300 has a total of five line-type recording heads corresponding to the reaction liquid in addition to four colors of Y (yellow), M (magenta), C (cyan), and Bk (black). The number of colors and the number of recording heads are not limited to five, but may be 1, 2, 3, 4, or 6 or more. The ink jet method may employ various methods such as a method using a heating element, a method using a piezo element, a method using an electrostatic element, a method using a MEMS (Micro Electro Mechanical Systems) element, etc. Ink of each color is supplied from a corresponding ink tank (not shown) to the corresponding recording head via an corresponding ink tube. The sheet on which an ink image has been formed by the recording portion 2300 is conveyed by the print belt unit 2200 to an inline scanner (not shown) arranged on the downstream side of the recording portion 2300. The inline scanner (not shown) detects the deviation and color density of the ink image formed on the sheet by the recording portion 2300, and the detection result is used to correct the ink image formed thereafter.

### Drying Module

The drying module 3000 includes a decoupling portion 3200, a drying belt unit 3300, and a hot air blowing portion 3400. The drying module 3000 is a unit that reduces the liquid content contained in the ink applied to the sheet by the recording portion 2300 and improves a fixing property between the sheet and the ink. The sheet on which the ink image is formed by the recording portion 2300 of the print module 2000 is conveyed to the decoupling portion 3200 arranged in the drying module 3000. The decoupling portion 3200 applies a wind pressure from above to hold the sheet on the belt weakly so that the sheet is conveyed by the frictional force of the belt. Thus, the sheet on which the ink image is formed by the recording portion 2300 can be prevented from shifting on the print belt unit 2200. The sheet conveyed from the decoupling portion 3200 is sucked and conveyed by the drying belt unit 3300, and hot air is blown from the hot air blowing portion 3400 arranged above the drying belt unit 3300 to the sheet to dry the ink applying surface of the sheet. In addition to the method of applying hot air, the drying method may be a method of irradiating the surface of the sheet with electromagnetic waves (ultraviolet rays, infrared rays, etc.), a conduction heat transfer method of bringing a heating element into contact with the surface of the sheet, or a method of combining these methods.

### Fixing Module

The fixing module 4000 includes a fixing belt unit 4100 and a first reversing portion 4200. The fixing belt unit 4100 can fix the ink to the sheet by passing the sheet conveyed from the drying module 3000 between a heated upper unit and a lower belt unit. The first reversing portion 4200 is provided in a duplex-printing conveyance portion of the fixing module 4000 and reverses the front and back sides of the sheet.

### Cooling Module

The cooling module 5000 includes a plurality of cooling portions 5100 configured to cool the high-temperature sheet conveyed from the fixing module 4000. The cooling portion 5100 takes an outside air into a cooling box by a fan and increases a pressure in the cooling box to apply the air blown out from nozzles formed in a conveyance guide to the sheet to cool the sheet. The cooling portion 5100 is arranged on each of both sides of the conveyance path across the conveyance path and can cool the sheet from both sides.

The cooling module 5000 also includes a conveyance-path switching portion 5200. The conveyance-path switching portion 5200 can switch the conveyance path of the sheet according to the case where the sheet is conveyed to the reversing module 6000 and the case where the sheet is conveyed to a duplex-printing conveyance path 1400 used in a duplex printing. During the duplex printing, the sheet is conveyed to a conveyance path 5300 in a lower portion of the cooling module 5000 by the conveyance-path switching portion 5200. The sheet is conveyed from the conveyance path 5300 to the duplex-printing conveyance path 1400 in the feeding module 1000 through a conveyance path 4300 in the fixing module 4000, a conveyance path 3500 in the drying module 3000, and a conveyance path 2400 in the print module 2000. The sheet is again conveyed from the duplex-printing conveyance path 1400 to the before-image-formation registration correction portion 2100 of the print module 2000, the print belt unit 2200, and the recording portion 2300, and an ink image is formed on the sheet by the recording portion 2300.

### Reversing Module

The reversing module 6000 has a second reversing portion 6400. The second reversing portion 6400 reverses the front and back sides of the conveyed sheet. Thus, the reversing module 6000 can change the front and back sides of the discharged sheet.

### Discharge Stacking Module

The discharge stacking module 7000 includes a top tray 7200 and a stacking portion 7500. The discharge stacking module 7000 aligns and stacks the sheet conveyed from the reversing module 6000 on the top tray 7200 or the stacking portion 7500.

### Structure of Feeding Module

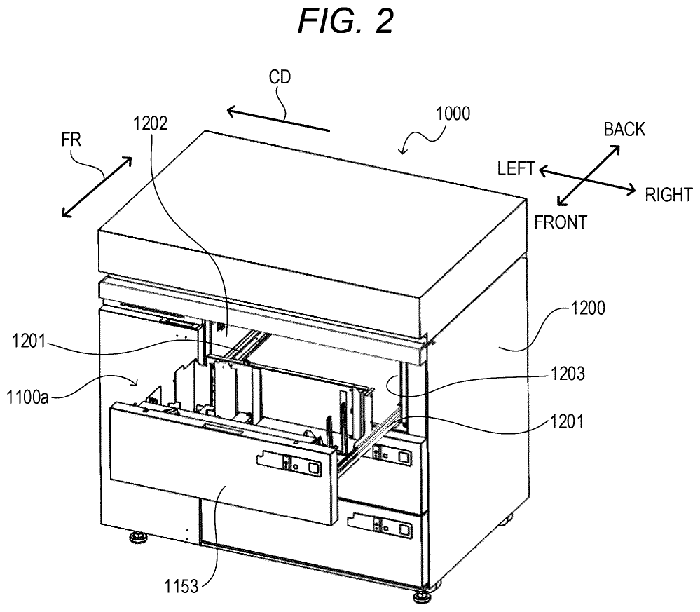

Next, the structure of the feeding module 1000 will be described. FIG. 2 is a perspective view of the feeding module 1000 in a state in which the storage 1100a is pulled out. Since the storages 1100a, 1100b, and 1100c have the same structure in the embodiment, the storage 1100a will be described below. However, the storages 1100a, 1100b, and 1100c need not necessarily have the same structure. For example, the storages 1100a, 1100b, and 1100c may be configured to have different heights so that the maximum number of sheets to be stacked differs.

The storage 1100a is mounted to a main body frame (feeding frame) 1200 of the feeding module 1000 in a drawable manner. The storage 1100a is held by a left side plate 1202 and a right side plate 1203 provided on the main body frame 1200 via slide rails 1201. The storage 1100a is held by the main body frame 1200 so as to be movable in a front-back direction FR between a closed position (mounting position) in which the storage 1100a is pushed in toward the back side of the main body frame 1200 and a pullout position in which the storage 1100a is pulled out toward the front side of the main body frame 1200. In a state in which the storage 1100a is in the pullout position, sheets can be added to the storage 1100a or replace the sheets in the storage 1100a.

The recording portion 2300 of the print module 2000 has a print head. A print gap, which is a clearance between the print head and the sheet, greatly affects image quality. When the sheet touches the print head due to deformation of the sheet, it is called a head touch. The head touch not only degrades the quality of the product but may also lead to breakage of the print head. In a case in which the ink jet recording apparatus 10 is installed in a high humidity environment, the sheet before image formation in the storage 1100a absorbs moisture of the installation environment and generates undulations. The deformation of the sheet caused by such undulations increases the head touches. Therefore, in order to prevent the air of the high humidity environment from flowing into the storage 1100a even in the case in which the ink jet recording apparatus 10 is installed in the high humidity environment, it is necessary to seal the storage 1100a to some extent to reduce the moisture absorbed by the sheet from the installation environment. Hereinafter, the sealed configuration of the storage 1100a will be described.

### Storage

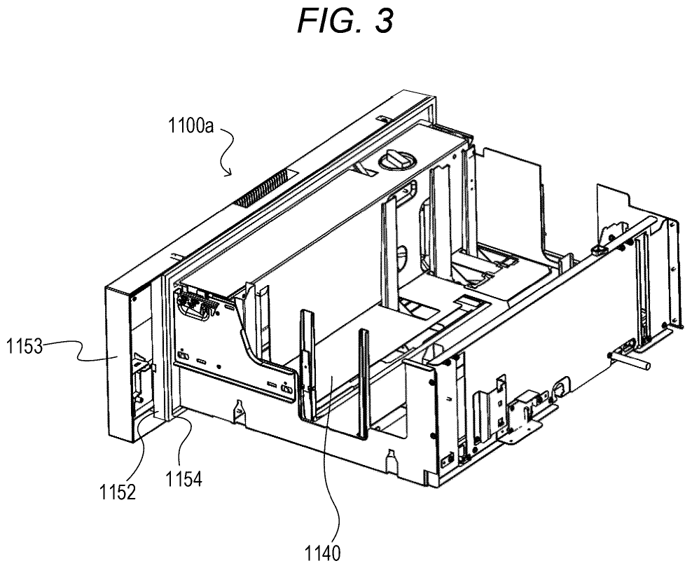

FIG. 3 is a perspective view of the storage 1100a. The storage 1100a is provided with a sheet placing portion 1140, on which a sheet is placed, and is configured to have a sealability for suppressing intrusion of moisture from outside air into the storage 1100a. The storage 1100a is provided with a sealing plate (front plate) 1152. An exterior cover 1153 is fixed to the front side of the sealing plate 1152. A hermetic seal 1154 is fixed to the back side of the sealing plate 1152. When the storage 1100a is pushed into and mounted to the main body frame 1200, the hermetic seal 1154 fills the gap between the storage 1100a and the main body frame 1200 to suppress the intrusion of moisture from the outside air into the storage 1100a. Since the sealability of the storage 1100a alone cannot prevent the inflow of the outside air, the main body frame 1200 also needs a sealability. Hereinafter, the configuration of the main body frame 1200 will be described.

### Main Body Frame

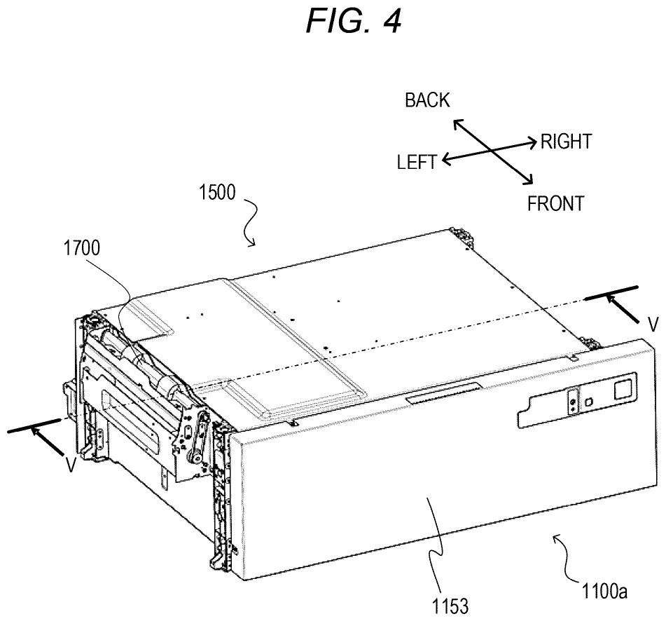

FIG. 4 is a perspective view of a sealed frame 1500 and the storage 1100a. The main body frame 1200 has the sealed frame (storage frame) 1500 configured to store the storage 1100a. The storage 1100a is mounted to be able to be pulled out from the sealed frame 1500. The sealed frame 1500 is provided in the main body frame 1200 (feeding frame) and is configured to have the sealability for suppressing the intrusion of moisture from outside air. The sealed frame 1500 is provided corresponding to each of the storages 1100a, 1100b and 1100c. That is, the storages 1100a, 1100b and 1100c and the three sealed frames 1500 are configured in one-to-one correspondence. The internal configuration of the sealed frame 1500 will be described below.

### Sealed Frame

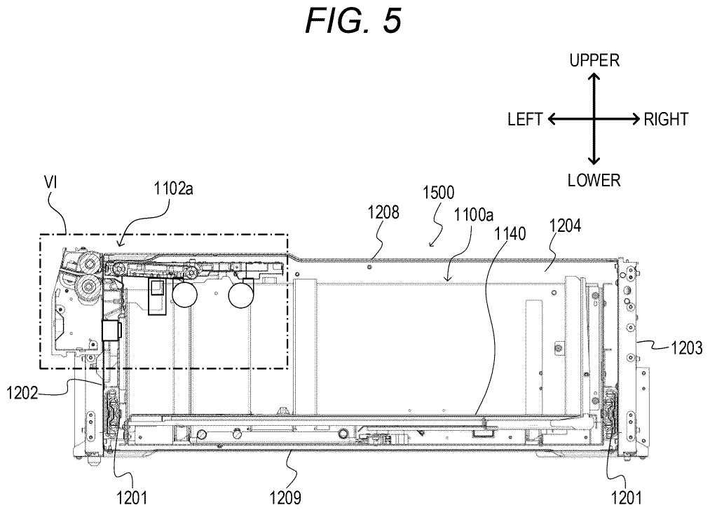

FIG. 5 is a cross-sectional view of the sealed frame 1500 and the storage 1100a taken along line V-V in FIG. 4. The sealed frame 1500 has a box-shaped configuration with an opening portion in the front surface and comprises the left side plate 1202, the right side plate 1203, a back side plate 1204, an upper side plate 1208, and a lower side plate 1209. The joints between the side plates are covered with seal members so as not to create gaps in the joints between the side plates. The opening portion formed in the front surface of the sealed frame 1500 is covered by the sealing plate (front side plate) 1152 of the storage 1100a. When the storage 1100a is pushed into and mounted to the sealed frame 1500 through the opening portion, the hermetic seal 1154 (FIG. 3) fixed to the sealing plate (front side plate) 1152 prevents outside air from entering the storage 1100a.

### Feeding Portion

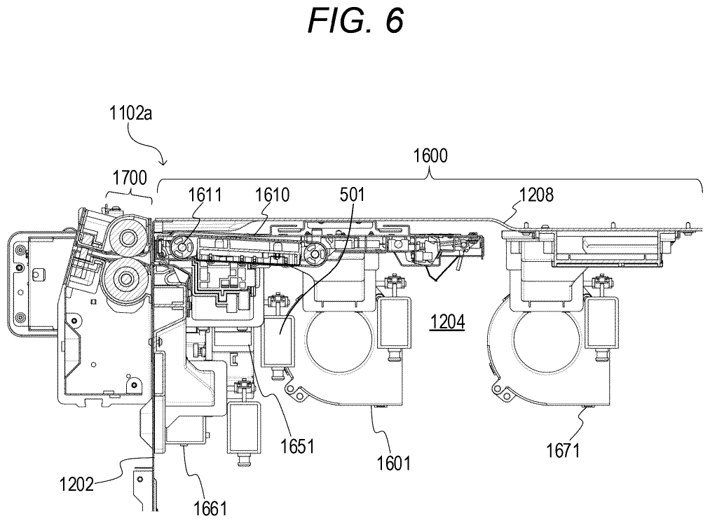

The sealed frame 1500 is provided with a feeding portion 1102a. FIG. 6 is an enlarged cross-sectional view of a portion enclosed by a dot and dash line rectangle VI in FIG. 5. The feeding portion 1102a has a feeding unit (sheet feeding portion) 1600 and a conveyance roller unit (draw roller unit) 1700. The feeding unit 1600 has a separation belt 1610 as a separation unit configured to separate and feed sheets one by one from a bundle of sheets placed on the sheet placing portion 1140 of the storage 1100a. The separation belt 1610 is driven by a motor 1611 as a driving portion. The sealed frame 1500 stores the storage 1100a, the feeding unit 1600, and the motor 1611.

The conveyance roller unit 1700 has a conveyance roller configured to convey the sheet separated by the feeding unit 1600. The separation belt 1610, a first suction fan 1601, a second suction fan 1671, and a side fan 1651 are arranged on the back side plate 1204. The first suction fan 1601 sucks air to suck the sheet to the separation belt 1610. The second suction fan 1671 sucks air to suck a trailing end of the sheet. The side fan 1651 blows side air in a direction facing the conveyance direction to assist the separation of the sheet by the separation belt 1610.

The slide rails 1201 configured to slidably hold the storage 1100a are disposed on the left side plate 1202 and the right side plate 1203, respectively. A front fan 1661 is disposed on the left side plate 1202. The front fan 1661 blows front air from upstream to downstream in the conveyance direction to assist the separation of the sheet by the separation belt 1610. The first suction fan 1601, the second suction fan 1671, the side fan 1651, and the front fan 1661 may be provided with shutters (not shown) configured to block the flow of air. The shutter (not shown) may be configured to be opened and closed by, for example, a solenoid 501 as an electrical component. Electrical components such as a fed sheet sensor (not shown) configured to detect a sheet and a storage opening/closing sensor (not shown) configured to detect whether the storage 1100a is closed are provided inside the sealed frame 1500. Electrical components such as a temperature and humidity sensor (not shown) configured to detect temperature and humidity in the sealed frame 1500 and a storage sheet sensor (not shown) are further provided inside the sealed frame 1500. These electrical components are supplied via a cable 1511 from a power supply portion 1510 provided outside the sealed frame 1500. The power supply portion 1510 may be a supply port of a power source, an outlet, or the like. Hereinafter, the configuration of the cable 1511 and the sealed frame 1500 will be described.

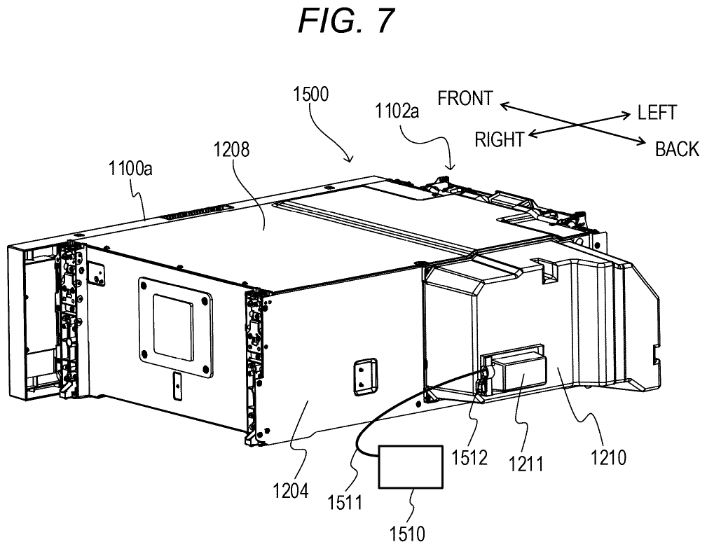

FIG. 7 is a perspective view of the sealed frame 1500 as seen from the back side. The electrical components such as the fan and the motor 1611 inside the sealed frame 1500 are concentrated on the back side plate 1204. The back side plate 1204 is provided with an opening portion so that the electrical components can be accessed without removing the back side plate 1204 itself, and the opening portion is covered by a sealing cover 1210. Since the sealing cover 1210 can be removed and the electrical components inside the sealed frame 1500 can be accessed through the opening portion, workability when the electrical components are replaced or repaired can be improved. The power supply portion 1510 provided outside the sealed frame 1500 is provided behind the main body frame (feeding frame) 1200. The electrical components provided inside the sealed frame 1500 and the power supply portion 1510 provided outside the sealed frame 1500 are connected by the cable 1511. The electrical components include the fans, the sensors, the solenoid 501, the motor 1611, and so on. The sealed frame 1500 may store all these electrical components, some of these electrical components, or one of these electrical components. For example, the fans, the sensors, and the solenoid 501 may be arranged inside the sealed frame 1500, and the motor 1611 may be arranged outside the sealed frame 1500. The electrical components are not limited to these and may be other electrical components. The cable 1511 extends from the inside to the outside of the sealed frame 1500 through the opening portion 1512 provided in the sealing cover 1210. Hereinafter, the configuration of the opening portion 1512 of the sealing cover 1210 and the cable 1511 will be described.

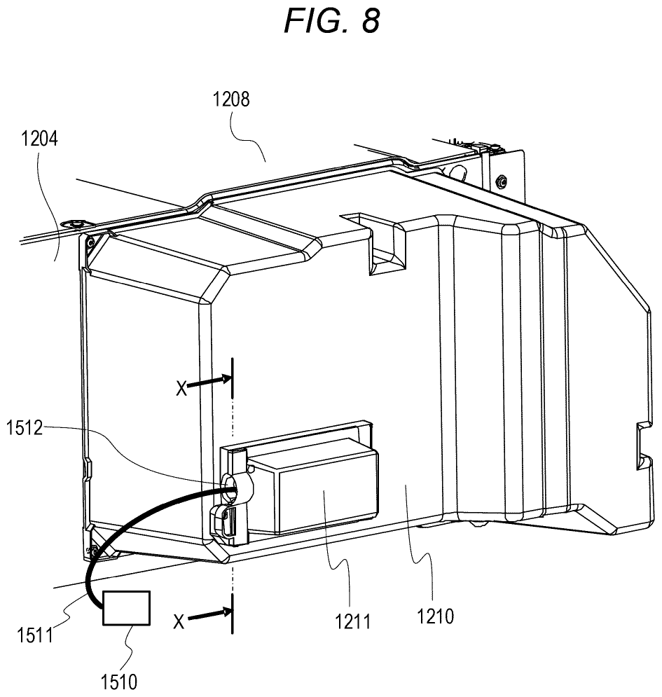

FIG. 8 is a perspective view of the sealing cover 1210 attached to the back side plate 1204. The sealing cover 1210 has a sealing lid 1211 attached to cover the opening portion provided in the sealing cover 1210. The opening portion 1512 through which the cable 1511 extends is defined by the sealing cover 1210 and the sealing lid 1211. The sealing cover 1210 is formed with one portion of the opening portion 1512, and the sealing lid 1211 is formed with the other portion of the opening portion 1512. The opening portion 1512 is formed by aligning the other portion of the opening portion 1512 of the sealing lid 1211 with one portion of the opening portion 1512 of the sealing cover 1210, and attaching the sealing lid 1211 to the sealing cover 1210. In the embodiment, the opening portion 1512 is formed by the sealing cover 1210 and the sealing lid 1211, but the opening portion 1512 may be formed only by the sealing cover 1210 or only by the sealing lid 1211.

To ensure the sealability, the size of the opening portion 1512 must be as small as possible with respect to the cable 1511. However, it is difficult to eliminate the gap between the opening portion 1512 and the cable 1511 only by the configurations of the opening portion 1512 and the cable 1511. If there is a gap between the opening portion 1512 and the cable 1511, the cable 1511 may move to one side of the opening portion 1512 due to the stiffness (tendency to bend) of the cable 1511 depending on how the cable 1511 is rotated, and the effect of the gap may be enlarged. Therefore, in the embodiment, a seal member 1513 is provided between the opening portion 1512 and the cable 1511 to ensure the sealability.

### Seal Member

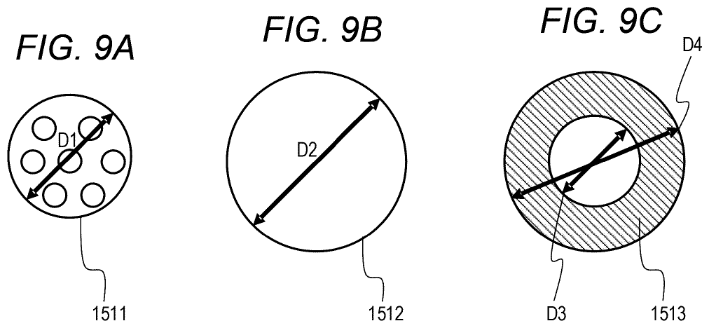

FIG. 9A is a schematic view of a cross section of the cable 1511. FIG. 9B is a schematic view of a cross section of the opening portion 1512. FIG. 9C is a schematic view of a cross section of the seal member 1513. In the embodiment, the seal member 1513 having elasticity and a cylindrical shape is provided in the opening portion 1512 in order to fill a gap between the opening portion 1512 and the cable 1511 and to ensure the sealability. The seal member 1513 is an elastic member such as a sponge. The seal member 1513 fits around an outer periphery of the cable 1511 to seal the opening portion 1512 between the sealing cover 1210 and the cable 1511 and the opening portion 1512 between the sealing lid 1211 and the cable 1511. FIG. 9A shows an outer diameter (wire diameter) D1 of the cable 1511. FIG. 9B shows an inner diameter (diameter) D2 of the opening portion 1512. FIG. 9C shows an inner diameter D3 and an outer diameter D4 of the seal member 1513.

The outer diameter D1 of the cable 1511 is larger than the inner diameter D3 of the seal member 1513 abutting against the cable 1511 (D1>D3). The inner diameter D2 of the opening portion 1512 is larger than the outer diameter DI of the cable 1511 (D2>D1). The inner diameter D2 of the opening portion 1512 is equal to or smaller than the outer diameter D4 of the seal member 1513 abutting against the opening portion 1512 (D2≤D4). In the embodiment, a compression amount (D1−D3) by which the seal member 1513 is compressed by the cable 1511 is set to be larger than the gap (D2−D1) between the cable 1511 and the opening portion 1512.

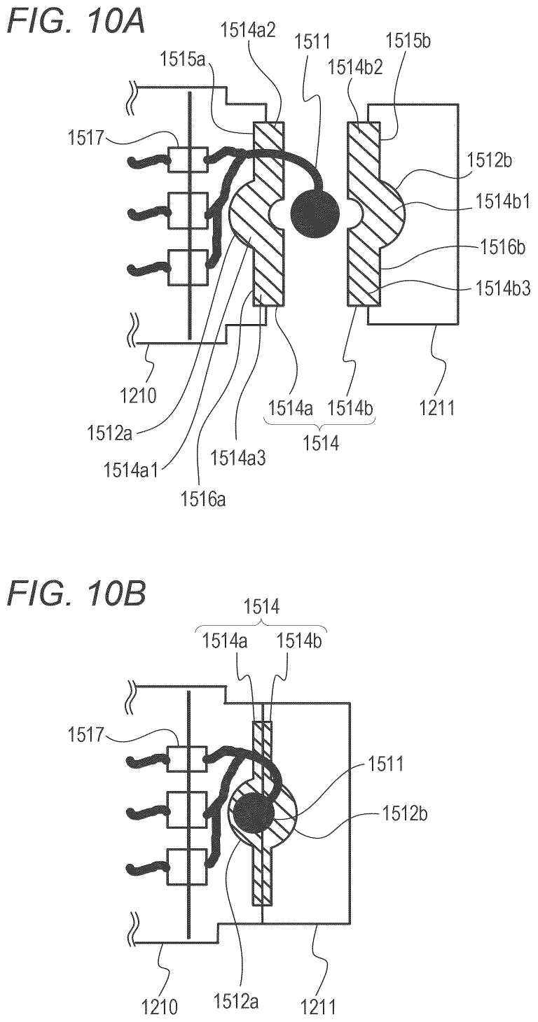

That is, the outer diameter DI of the cable 1511, the inner diameter D2 of the opening portion 1512, and the inner diameter D3 of the seal member 1513 abutting against the cable 1511 satisfy the relationship D1−D3>D2−D1. Thus, even if the cable 1511 moves to one side in the opening portion 1512, the gap between the cable 1511 and the opening portion 1512 is sealed by the elastic expansion of the seal member 1513. That is, by surrounding the cable 1511 with the seal member 1513 having the compression amount of a predetermined amount, even if the cable 1511 moves to one side in the opening portion 1512 so that the seal member 1513 is compressed, the seal member 1513 expands so as not to form a gap on the other side. This makes it possible to secure the sealability of the opening portion 1512 through which the cable 1511 extends. The seal member 1513 of the embodiment is formed in an integral cylindrical shape. However, the seal member 1513 may be configured to be wound around the outer periphery of the cable 1511. The seal member 1513 may be divided into two parts. A two-part seal member 1514 according to another embodiment will be described below with reference to FIG. 10A and FIG. 10B.

### Two-Part Seal Member

FIG. 10A and FIG. 10B are cross-sectional views of the two-part seal member 1514 taken along line X-X in FIG. 8. FIG. 10A is a view showing the sealing cover 1210 and the sealing lid 1211 separated. FIG. 10B is a view showing the sealing cover 1210 and the sealing lid 1211 coupled. The two-part seal member 1514 comprises a first seal member 1514a and a second seal member 1514b. The first seal member 1514a has a halved cylindrical portion 1514a1 and extended portions 1514a2 and 1514a3 extending outwardly from both ends of the halved cylindrical portion 1514a1. Similarly, the second seal member 1514b has a halved cylindrical portion 1514b1 and extended portions 1514b2 and 1514b3 extending outwardly from both ends of the halved cylindrical portion 1514b1.

An opening portion through which the cable 1511 extends is defined by a halved opening portion 1512a provided in the sealing cover (one portion of the sealed frame 1500) 1210 and a halved opening portion 1512b provided in the sealing lid (the other portion of the sealed frame 1500) 1211. The sealing cover 1210 is provided with recessed portions 1515a and 1516a extending from both ends of the halved opening portion 1512a. The sealing lid 1211 is provided with recessed portions 1515b and 1516b extending from both ends of the halved opening portion 1512b. The halved cylindrical portion 1514a1 of the first seal member 1514a is fitted into the halved opening portion 1512a, and the extended portions 1514a2 and 1514a3 are fitted into the recessed portions 1515a and 1516a, respectively. The first seal member 1514a seals the halved opening portion 1512a between the sealing cover 1210 and the cable 1511. The halved cylindrical portion 1514b1 of the second seal member 1514b is fitted into the halved opening portion 1512b, and the extended portions 1514b2 and 1514b3 are fitted into the recessed portions 1515b and 1516b, respectively. The second seal member 1514b seals the halved opening portion 1512b between the sealing lid 1211 and the cable 1511.

The cable 1511 is connected to the electrical component in the sealed frame 1500 via a connector 1517 provided in the sealing cover 1210. In FIG. 10B, the cable 1511 is drawn over the first seal member 1514a and the second seal member 1514b, but the cable 1511 does not penetrate the first seal member 1514a and the second seal member 1514b. In the embodiment, the cable 1511 is routed around the first seal member 1514a and the second seal member 1514b. The cable 1511 is sandwiched between the halved cylindrical portion 1514a1 of the first seal member 1514a and the halved cylindrical portion 1514b1 of the second seal member 1514b, and the sealing lid 1211 is attached to the sealing cover 1210. The sealing lid 1211 may be secured to the sealing cover 1210 by a fastening member such as a screw.

The first seal member 1514a seals between the cable 1511 and the halved opening portion 1512a on one side of the cable 1511. The second seal member 1514b seals between the cable 1511 and the halved opening portion 1512b on the other side of the cable 1511. The first seal member 1514a and the second seal member 1514b each have the compression amount of the predetermined amount. When the cable 1511 is enclosed by the first seal member 1514a and the second seal member 1514b, the cable 1511 may move to one side in the opening portion as shown in FIG. 10B. For example, even if the cable 1511 moves to the first seal member 1514a on one side in the opening portion so that the first seal member 1514a is compressed, the second seal member 1514b on the other side expands. As a result, the opening portion formed by the halved opening portion 1512a and the halved opening portion 1512b is sealed by the first seal member 1514a and the second seal member 1514b so as not to form a gap, thereby ensuring the sealability.

According to the embodiment, even if the cable 1511 is arranged with moved to one side in the opening portion, since the seal member has a sufficient compression amount, the opening portion can be sealed by the seal member without a gap being formed between the cable 1511 and the opening portion. According to the embodiment, in the feeding module 1000 mounted to the ink jet recording apparatus 10, it is possible to provide the sealed configuration for maintaining moisture resistance in the feeding module 1000. According to the embodiment, it is possible to suppress intrusion of moisture from outside air into the sealed frame 1500 provided with the opening portion 1512 through which the cable 1511 extends, while suppressing enlargement of the feeding module 1000.

In the above-described embodiment, the hermetic seal 1154 (FIG. 3) is arranged in the storage 1100a. However, if the sealing state can be achieved by filling the gap between the storage 1100a and the main body frame 1200 by the hermetic seal, the hermetic seal may be arranged in the main body frame 1200.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-192099, filed Nov. 10, 2023, which is hereby incorporated by reference herein in its entirety.

What is claimed is:

1. A sheet stacking apparatus comprising:
a storage on which a sheet is placed;
a sheet feeding portion configured to feed the sheet placed on the storage;
an electrical component;
a storage frame in which the storage and the electrical component are stored;
a power supply portion provided outside the storage frame and configured to supply power to the electrical component;
a cable configured to connect the electrical component and the power supply portion via an opening portion provided in the storage frame; and
a seal member provided between the opening portion and the cable.

2. The sheet stacking apparatus according to claim 1, wherein the storage frame stores the sheet feeding portion.

3. The sheet stacking apparatus according to claim 1, wherein the seal member is an elastic member,
wherein the opening portion is defined by one portion and the other portion of the storage frame, and
wherein the seal member comprises a first seal member configured to seal the opening portion between the one portion of the storage frame and the cable and a second seal member configured to seal the opening portion between the other portion of the storage frame and the cable.

4. The sheet stacking apparatus according to claim 1, wherein the seal member is an elastic member,
wherein the seal member is wound around an outer periphery of the cable, and
wherein the seal member seals the opening portion between the cable and the storage frame.

5. The sheet stacking apparatus according to claim 1, wherein the seal member is an elastic member,
wherein the seal member has a cylindrical shape fitted onto an outer periphery of the cable, and
wherein the seal member seals the opening portion between the cable and the storage frame.

6. The sheet stacking apparatus according to claim 1, where an outer diameter D1 of the cable, an inner diameter D2 of the opening portion, and an inner diameter D3 of the seal member abutting against the cable satisfy a relationship of D1−D3>D2−D1.

7. The sheet stacking apparatus according to claim 1, wherein the electrical component is a fan configured to blow air to the sheet placed on the storage.

8. The sheet stacking apparatus according to claim 1, wherein the electrical component is a sensor configured to detect the sheet.

9. The sheet stacking apparatus according to claim 1, wherein the seal member is a sponge.

10. The sheet stacking apparatus according to claim 1, wherein the storage frame includes a sealing cover removably attached to the storage frame, and
wherein the opening portion is provided in the sealing cover.

11. The sheet stacking apparatus according to claim 10, wherein the storage frame includes a sealing lid attached to the sealing cover, and
wherein the opening portion is defined by a first halved opening portion provided in the sealing cover and a second halved opening portion provided in the sealing lid.

12. The sheet stacking apparatus according to claim 1, wherein the seal member has a first seal member having a first halved cylindrical portion and a second seal member having a second halved cylindrical portion.

13. An image forming apparatus comprising:
an image forming portion configured to form an image on a sheet; and
a sheet stacking apparatus on which the sheet on which the image is formed by the image forming portion is stacked, the sheet stacking apparatus including:
a storage on which the sheet is placed;
a sheet feeding portion configured to feed the sheet placed on the storage;
an electrical component;
a storage frame in which the storage and the electrical component are stored;
a power supply portion provided outside the storage frame and configured to supply power to the electrical component;
a cable configured to connect the electrical component and the power supply portion via an opening portion provided in the storage frame; and
a seal member provided between the opening portion and the cable.
